(19) United States
(12) Patent Application Publication
(10) Pub. No.: US 2022/0236368 A1
(43) Pub. Date: Jul. 28, 2022

(54) Transmission Control Method and Related Device

(71) Applicant: Huawei Technologies Co., Ltd., Shenzhen (CN)

(72) Inventors: Sida Song, Beijing (CN); Sha Ma, Beijing (CN); Lei Gao, Beijing (CN); Qian Wu, Beijing (CN)

(21) Appl. No.: 17/717,646

(22) Filed: Apr. 11, 2022

Related U.S. Application Data
(63) Continuation of application No. PCT/CN2020/093118, filed on May 29, 2020.

(30) Foreign Application Priority Data
Oct. 11, 2019 (CN) 201910965504.X

(51) Int. Cl. G01S 7/02; H04L 5/00; G01S 7/28; G01S 13/20

(52) U.S. Cl. CPC G01S 7/023; G01S 13/20; G01S 7/2813; H04L 5/0073

(57) ABSTRACT

A transmission control method includes steps for obtaining interference information of a first radar on a first frequency band, for example, through listening before transmission. The interference information represents a degree to which the first radar is interfered with on the first frequency band. Transmission duration of the first radar on the first frequency band is determined based on the interference information, where the interference information indicates either a difference between the transmission duration and an initial transmission duration of the first radar, or the transmission duration.

### CROSS-REFERENCE TO RELATED APPLICATIONS

This is a continuation of International Patent Application No. PCT/CN2020/093118 filed on May 29, 2020, which claims priority to Chinese Patent Application No. 201910965504.X filed on Oct. 11, 2019. The disclosures of the aforementioned applications are hereby incorporated by reference in their entireties.

### TECHNICAL FIELD

This disclosure relates to the field of radar technologies, and in particular, to a transmission control method and a related device.

### BACKGROUND

With the development of society, increasingly more machines in the modern life develop towards automation and intelligentization, and a vehicle used for mobile traveling is no exception. An intelligent vehicle is entering the daily life of people. In recent years, an advanced driver-assistance systems (ADAS) has played an important role in an intelligent vehicle, and uses various sensors installed on the vehicle, to sense a surrounding environment at any time when the vehicle is driving, collect data, identify, detect, and trace stationary and moving objects, and perform systematic operation and analysis in combination with navigator map data, so as to make a driver aware of possible risks in advance and effectively improve comfort and safety of vehicle driving. Therefore, real unmanned driving is an ultimate product of development of the ADAS. In an architecture of unmanned driving, a sensing layer is referred to as an “eye” of a vehicle, and includes a vision sensor such as an on-board camera and a radar sensor such as an on-board millimeter-wave radar, an on-board laser radar, and an on-board ultrasonic radar. The millimeter-wave radar has become a main sensor of an unmanned driving system due to low costs and a mature technology. The ADAS has developed more than ten functions, including adaptive cruise control (ACC), automatic emergency braking (AEB), lane change assist (LCA), and blind spot detection (BSD).

In the conventional technology, an on-board radar continuously transmits a signal during working. FIG. 1 is a schematic diagram in which an existing on-board radar transmits a signal. Each working frame includes a plurality of consecutive periodic signals and a plurality of consecutive idle times. Because of a relatively high duty cycle, the idle time actually occupies a relatively small proportion of time in an entire transmit frame. The working frames of the radar are consecutive. For example, a working frame 1 is followed by a working frame 2, and the working frame 2 is followed by a working frame 3. The existing on-board radar may occupy a spectrum resource for a long time.

Therefore, how to ensure that a plurality of radars evenly share resources as much as possible is a technical problem that needs to be resolved urgently.

### SUMMARY

Embodiments provide a transmission control method and a related device, so as to ensure that a plurality of radars evenly share resources as much as possible and improve working efficiency of the radars.

According to a first aspect, an embodiment provides a transmission control method. The method may include obtaining interference information, where the interference information is used to represent first information of a degree to which a first radar is interfered with on a first frequency band, and determining first transmission duration of the first radar on the first frequency band based on the interference information, where the interference information is used to indicate a difference between the first transmission duration and initial transmission duration of the first radar, or the interference information is used to indicate the first transmission duration.

In embodiments of this disclosure, the interference information of the first radar on the first frequency band is first obtained. The interference information represents the degree to which the first radar is interfered with on the first frequency band. A device determines the first transmission duration of the first radar on the first frequency band based on the obtained interference information, where transmission duration corresponding to a high degree of interference is less than transmission duration corresponding to a low degree of interference, and controls the transmission duration of the first radar on the first frequency band based on the determined transmission duration. The transmission duration of the radar is controlled by using the interference information, and transmission duration of continuously occupying a resource is adjusted, so as to avoid a case in which one radar continuously occupies a frequency resource, and correspondingly control a length of the duration based on intensity of the interference. Therefore, it can be ensured that a plurality of radars evenly share resources, and interference is effectively avoided. This improves working efficiency of the radars.

In a possible implementation, the interference information includes a quantity of radars that are interfered with on the first frequency band, or includes density information of radars that are interfered with on the first frequency band. Both the quantity and the density information of radars that are interfered with can visually describe the degree to which the first radar is interfered with. This provides effective information for subsequently determining transmission duration.

In a possible implementation, obtaining interference information includes performing interference detection on the first frequency band to obtain the interference information, or receiving the interference information, where the interference information is from at least one second apparatus, and the second apparatus includes a second radar or a roadside unit. This implementation provides two manners of obtaining the interference information, including a manner of actively obtaining the interference information through interference detection and a manner of passively receiving the interference information by using a communications device. This can improve efficiency of obtaining the interference information.

In a possible implementation, the interference information belongs to a first interference range in a plurality of interference ranges, and the plurality of interference ranges are defined by using at least one interference threshold. In this implementation, a specific interference range that is in the plurality of interference ranges and to which the interference information belongs is determined, so as to determine the transmission duration of the first radar, thereby effectively avoiding interference from another radar, and ensuring fairness of resource sharing between a plurality of radars while satisfying a detection requirement of the first radar.

In a possible implementation, the at least one interference threshold is predefined or preconfigured. In this implementation, the plurality of interference ranges is determined by using the at least one preset interference threshold, so as to determine a specific interference range that is in the plurality of interference ranges and to which the interference information belongs, and determine the transmission duration of the first radar.

In a possible implementation, the interference information further includes second information used to represent a degree to which the first radar is interfered with by another radar on a second frequency band, and the degree to which the first radar is interfered with on the second frequency band is higher than the degree to which the first radar is interfered with on the first frequency band. In this implementation, a transmit frequency band is determined by obtaining and comparing interference information on different frequency bands, and transmission duration is subsequently determined based on interference information on the transmit frequency band, so that mutual interference between radars can be better avoided.

According to a second aspect, an embodiment provides another transmission control method, including sending interference information to a first apparatus, where the interference information includes first information used to represent a degree to which the first apparatus is interfered with on a first frequency band, and the interference information is used by the first apparatus to determine first transmission duration on the first frequency band.

In embodiments of this disclosure, the interference information is sent to the first apparatus, to provide the interference information for the first apparatus, so as to determine the transmission duration of the first apparatus on the first frequency band. The transmission duration of the radar is controlled by using the interference information, and transmission duration of continuously occupying a resource is adjusted, so as to avoid a case in which one radar continuously occupies a frequency resource, and correspondingly control a length of the duration based on intensity of the interference. Therefore, it can be ensured that a plurality of radars evenly share resources, and interference is effectively avoided. This improves working efficiency of the radars.

In a possible implementation, the interference information includes a quantity of radars that are interfered with on the first frequency band, or includes density information of radars that are interfered with on the first frequency band. Both the quantity and the density information of radars that are interfered with can visually describe the degree to which the second apparatus is interfered with. This provides effective information for subsequently determining transmission duration.

According to a third aspect, an embodiment provides a transmission control apparatus, including an obtaining unit configured to obtain interference information, where the interference information is used to represent first information of a degree to which a first radar is interfered with on a first frequency band, and a determining unit configured to determine first transmission duration of the first radar on the first frequency band based on the interference information, where the interference information is used to indicate a difference between the first transmission duration and initial transmission duration of the first radar, or the interference information is used to indicate the first transmission duration.

In embodiments of this disclosure, the transmission control apparatus first obtains the interference information of the first radar on the first frequency band by using the obtaining unit. The interference information represents the degree to which the first radar is interfered with on the first frequency band. A device determines, by using the determining unit, the transmission duration of the first radar on the first frequency band based on the obtained interference information, where transmission duration corresponding to a high degree of interference is less than transmission duration corresponding to a low degree of interference, and controls the transmission duration of the first radar on the first frequency band based on the determined transmission duration. The transmission control apparatus controls the transmission duration of the radar by using the interference information, and adjusts transmission duration of continuously occupying a resource by the radar, so as to avoid a case in which one radar continuously occupies a frequency resource, and correspondingly control a length of the duration based on intensity of the interference. Therefore, it is ensured that a plurality of radars evenly share resources, and interference is effectively avoided. This improves working efficiency of the radars.

In a possible implementation, the interference information includes a quantity of radars that are interfered with on the first frequency band, or includes density information of radars that are interfered with on the first frequency band. Both the quantity and the density information of radars that are interfered with can visually describe the degree to which the first radar is interfered with. This provides effective information for subsequently determining transmission duration.

In a possible implementation, the first obtaining unit is further configured to perform interference detection on the first frequency band to obtain the interference information, or the obtaining unit further includes a receiving unit configured to receive the interference information, where the interference information is from at least one second apparatus, and the second apparatus includes a second radar or a roadside unit. This implementation provides two manners of obtaining the interference information by the obtaining unit in the apparatus, including a manner of actively obtaining the interference information through interference detection and a manner of passively receiving the interference information by using a communications device. This can improve efficiency of obtaining the interference information.

In a possible implementation, the interference information belongs to a first interference range in a plurality of interference ranges, and the plurality of interference ranges are defined by using at least one interference threshold. In this implementation, a specific interference range that is in the plurality of interference ranges and to which the interference information belongs is determined, so as to determine the transmission duration of the first radar, thereby effectively avoiding interference from another radar, and ensuring fairness of resource sharing between a plurality of radars while satisfying a detection requirement of the first radar.

In a possible implementation, the at least one interference threshold is predefined or preconfigured. In this implementation, the plurality of interference ranges is determined by using the at least one preset interference threshold, so as to determine a specific interference range that is in the plurality of interference ranges and to which the interference information belongs, and determine the transmission duration of the first radar.

In a possible implementation, the interference information further includes second information used to represent a degree to which the first radar is interfered with by another radar on a second frequency band, and the degree to which the first radar is interfered with on the second frequency band is higher than the degree to which the first radar is interfered with on the first frequency band. In this implementation, a transmit frequency band is determined by obtaining and comparing interference information on different frequency bands, and transmission duration is subsequently determined based on interference information on the transmit frequency band, so that mutual interference between radars can be better avoided.

According to a fourth aspect, an embodiment provides another transmission control apparatus, including a sending unit configured to send interference information to a first apparatus, where the interference information includes first information used to represent a degree to which the first apparatus is interfered with on a first frequency band, and the first information is used by the first apparatus to determine first transmission duration on the first frequency band.

In a possible implementation, the interference information includes a quantity of radars that are interfered with on the first frequency band, or includes density information of radars that are interfered with on the first frequency band. Both the quantity and the density information of radars that are interfered with can visually describe the degree to which the second apparatus is interfered with. This provides effective information for subsequently determining transmission duration.

According to a fifth aspect, an embodiment provides an electronic device. The electronic device includes at least one processor, and the processor is configured to support the terminal device in implementing a corresponding function in the transmission control method provided in the first aspect or the second aspect. The electronic device may further include a memory. The memory is configured to be coupled to the processor, and the memory stores program instructions and data that are necessary for the electronic device. The electronic device may further include a communications interface, used for communication between the electronic device and another device or a communications network.

According to a sixth aspect, an embodiment provides a computer storage medium configured to store computer software instructions used by a processor in the transmission control apparatus provided in the third aspect or the fourth aspect, and the computer software instructions include a program designed to execute the foregoing aspect.

According to a seventh aspect, an embodiment provides a computer program. The computer program includes instructions, and when the computer program is executed by a computer, the computer is enabled to execute a process executed by a processor in the transmission control apparatus in the third aspect or the fourth aspect.

According to an eighth aspect, this disclosure provides a chip system. The chip system includes at least one processor and an interface circuit, the interface circuit provides program instructions for the at least one processor, and when the program instructions are executed by the at least one processor, the at least one processor is configured to support an electronic device in implementing the functions in the first aspect or the second aspect, for example, generating or processing information in the transmission control method. In a possible design, the chip system further includes a memory, and the memory is configured to store program instructions and data that are necessary for a data sending device. The chip system may include a chip, or may include a chip and another discrete component.

### BRIEF DESCRIPTION OF DRAWINGS

To describe technical solutions in some of the embodiments more clearly, the following describes the accompanying drawings used in some of the embodiments.

FIG. 1 is a diagram of a principle of the conventional technology of a transmission control method according to an embodiment;

FIG. 2 is a schematic diagram of an application scenario of a transmission control method according to an embodiment;

FIG. 3 is a schematic diagram of a system architecture of a transmission control method according to an embodiment;

FIG. 4 is a schematic flowchart of a transmission control method according to an embodiment;

FIG. 5A is a schematic flowchart of another transmission control method according to an embodiment;

FIG. 5B is a schematic diagram of application control of a transmission control method according to an embodiment;

FIG. 5C is a schematic diagram of application control of a transmission control method according to an embodiment;

FIG. 6 is a schematic diagram of a transmission control apparatus according to an embodiment;

FIG. 7 is a schematic diagram of another transmission control apparatus according to an embodiment;

FIG. 8 is a schematic diagram of a structure of another transmission control apparatus according to an embodiment; and

FIG. 9 is a schematic diagram of an architecture of a transmission control system according to an embodiment.

### DESCRIPTION OF EMBODIMENTS

The following describes the embodiments of this disclosure with reference to the accompanying drawings in the embodiments.

The terms “first”, “second”, “third”, “fourth”, “fifth”, “sixth”, “seventh”, “eighth”, and the like in the specification, claims, and accompanying drawings of this disclosure are used to distinguish between different objects, and are not used to describe a specific sequence. In addition, the terms “include” and “have” and any variations thereof are intended to cover a non-exclusive inclusion. For example, a process, method, system, product, or device that includes a series of steps or units is not limited to the listed steps or units, but optionally further includes an unlisted step or unit, or optionally further includes another inherent step or unit of the process, method, product, or device.

“Embodiments” mentioned in the specification means that specific features, structures, or features described with reference to embodiments may be included in at least one embodiment of this disclosure. The phrase shown in various locations in this specification may not necessarily refer to a same embodiment, and is not an independent or optional embodiment exclusive from another embodiment. It is explicitly and implicitly understood by a person skilled in the art that embodiments described in this specification may be combined with another embodiment.

The terms “component”, “module”, “system”, and the like used in the specification are used to represent a computer-related entity, hardware, firmware, a combination of hardware and software, software, or software in execution. For example, the component may be, but is not limited to, a process, a processor, an object, an executable file, an execution thread, a program, and/or a computer running on a processor. As illustrated by using the figures, both a computing device and an application that runs on the computing device may be components. One or more components may reside in a process and/or an execution thread, and the components may be located on one computer and/or may be distributed between two or more computers. In addition, these components may be executed from various computer-readable media that store various data structures. The components may perform communication through a local and/or remote process, for example, based on a signal having one or more data packets (for example, data from two components that interact with another component between a local system, a distributed system, and/or a network, for example, the internet that interacts with another systems by using a signal).

It should be understood that the term “and/or” used in the specification and the appended claims means any combination of one or more of associated listed items and all possible combinations, and includes these combinations.

Some terms in this disclosure are first described, to help a person skilled in the art have a better understanding.

(1) Millimeter-wave radar: A millimeter wave is an electromagnetic wave with a wavelength of 1 to 10 millimeters (mm), and is characterized by a short wavelength and a wide frequency band. The millimeter wave easily implements a narrow beam, has a high radar resolution, and is not susceptible to interference. The millimeter-wave radar is a high-precision sensor for measuring a relative distance, a relative speed, and a direction between measured objects. The millimeter-wave radar is used in the military field in an early period. With development and progress of radar technologies, the millimeter-wave radar sensor is used in a plurality of fields such as automotive electronics, drones, and intelligent transportation. During application of an on-board millimeter-wave radar, the millimeter-wave radar is installed on a vehicle to obtain a distance, an angle, and a relative speed between measured objects from the radar through measurement. The millimeter-wave radar can implement ADAS functions such as ACC, forward collision avoidance warning, BSD, parking assist, LCA, and ACC. A 24 gigahertz (GHz) radar system mainly implements a short-range radar (SRR), and a 77 GHz system mainly implements a long-range radar (LRR).

The millimeter-wave radar emits a millimeter wave through an antenna, receives a target reflection signal, and quickly and accurately obtains physical environment information around a vehicle body (such as a relative distance, a relative speed, an angle, and a movement direction between a vehicle and another object) after rear processing. Then, the millimeter-wave radar performs target tracing and identification classification based on detected object information, and further performs data fusion with reference to dynamic information of the vehicle body. Finally, the millimeter-wave radar performs intelligent processing through a central processing unit (CPU). After a proper decision is made, a driver is notified or warned in various manners, such as sound, light, and tactile sense, or the vehicle is actively intervened in time, thereby ensuring safety and comfort of a driving process, and reducing an accident occurrence probability.

(2) V2X: Vehicle-to-everything, that is, vehicle-to-everything information exchange. By integrating a Global Positioning System (GPS) navigation technology, a vehicle-to-vehicle communications technology, a wireless communications technology, and a remote sensing technology, vehicle-to-everything establishes a new development direction of vehicle technologies, and implements compatibility between manual driving and self-driving. It implements communication between a vehicle and a vehicle, between a vehicle and a base station, and between a base station and a base station. In this way, a series of traffic information such as a real-time road condition, road information, and pedestrian information can be obtained. This improves driving safety, reduces congestion, improves traffic efficiency, provides in-vehicle infotainment information, and the like. In addition, by using an in-vehicle sensor and a camera system, a surrounding environment may be further perceived to perform rapid adjustment, so as to implement “zero traffic accident”. For example, if a pedestrian suddenly appears, the vehicle can automatically slow down to a safe speed or stop.

(3) Co-channel interference: The co-channel interference means that a carrier of an unwanted signal is the same as that of a wanted signal, and interference is caused to a receiver that receives a co-channel wanted signal.

(4) Roadside unit: The roadside unit is a static device, and may be independently deployed on two sides of a road or installed with a signal light, and is used for large-area sensing and communication. By using the roadside unit, a vehicle may access data stored in the roadside unit or upload data of the vehicle. The roadside unit collects vehicle safety information sent by an on board unit, and forwards the vehicle safety information to a road monitoring center. After summarizing safety information of each vehicle, the road monitoring center can monitor a road condition of the entire road and a running status of each vehicle. In addition, after receiving the road safety information sent by the road monitoring center, the roadside unit broadcasts the road safety information to vehicles on the road. The roadside unit uses the same mobile communications technology as the on board unit, and needs to communicate with the road monitoring center. In terms of function and structure, the roadside unit may be considered as a gateway in a heterogeneous network.

In addition, to facilitate understanding of the embodiments of the present disclosure, the following analyzes technical problems to be resolved in the embodiments of the present disclosure and corresponding application scenarios. In a process of radar transmission control, the following two solutions are usually used.

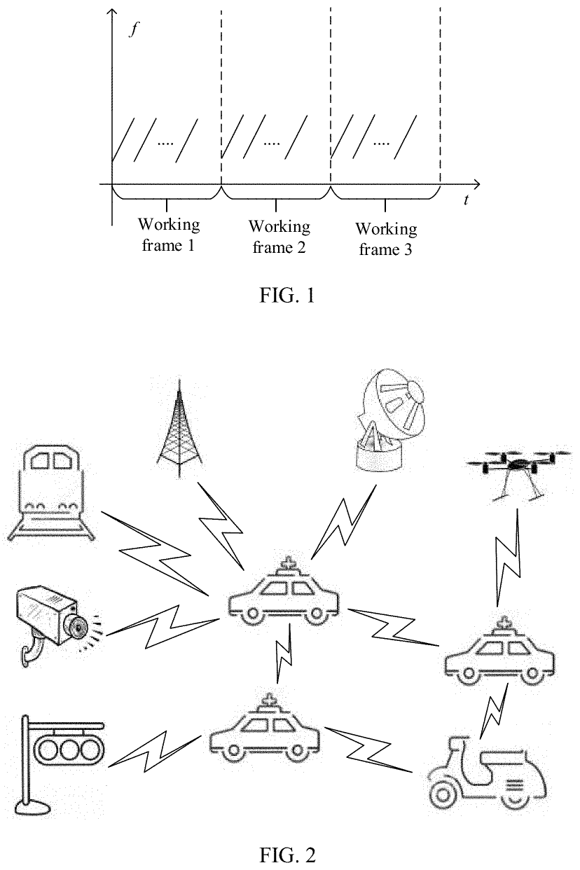

Solution 1: When an existing radar works, a transmit signal is continuously transmitted. As shown in FIG. 1, each working frame includes a plurality of consecutive periodic signals and a plurality of consecutive idle times. Because of a relatively high duty cycle, the idle time actually occupies a relatively small proportion of time in an entire transmit frame. The working frames of the radar are consecutive. For example, a working frame 1 is followed by a working frame 2, and the working frame 2 is followed by a working frame 3. However, the existing radar occupies a spectrum resource for a long time. This causes resource use unfairness. In a future case of high radar penetration, fairness and rationality of resource use are keys to ensure that the radar works normally without being affected by severe mutual interference in a full scenario.

Solution 2: A controller controls a controllable attenuator to generate different attenuation to attenuate a detection signal transmitted by a transmitter, so that a radar device separately works in a normal working state and an interference detection working state. In the interference detection working state, the controller determines an interference signal based on a dial-back signal received by a receiver, adjusts the detection signal of the transmitter based on the interference signal, and adjusts transmit power, a frequency band, or a modulation scheme of the detection signal, so as to avoid interference between different radar devices in a same area. However, in this implementation, the adjusted transmit power, frequency band, or modulation scheme can be used only in a next transmission period. In addition, in a process of determining the transmit power, the frequency band, or the modulation scheme, an example trial and error manner is used, and efficiency is not high.

Therefore, for the foregoing technical problem, a problem to be resolved in this disclosure is how to adjust, for different interference information, transmission duration of continuously occupying a same spectrum resource by a radar system, so that fairness of resource sharing between a plurality of radars is ensured on a same available frequency resource.

The following lists examples of scenarios to which a transmission control method in this disclosure is applied. As shown in FIG. 2, a radar may be installed on a motor vehicle, a drone, a railcar, a bicycle, a signal light, a speed measurement apparatus, a base station, or the like. These radars may transmit electromagnetic waves on a same frequency band or different frequency bands. This disclosure is applicable to a radar system between vehicles, a radar system between a vehicle and another apparatus such as a drone, or a radar system between other apparatuses. This disclosure sets no limitation on a location and a function of the radar.

It may be understood that the foregoing application scenarios are merely example implementations in embodiments of this disclosure, and application scenarios in embodiments of this disclosure include but are not limited to the foregoing application scenarios.

With reference to an architecture of a transmission control system provided in this disclosure and a procedure of a transmission control method provided based on the architecture of the transmission control system, the following further analyzes and resolves the technical problems in the foregoing solutions.

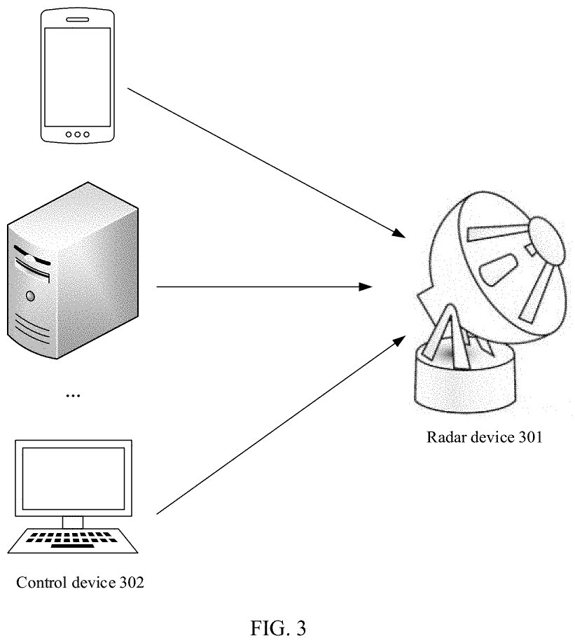

FIG. 3 is a schematic diagram of an architecture of a transmission control system according to an embodiment. In an application scenario of transmission control, the system may include a radar device 301 and a control device 302. The radar device 301 and the control device 302 may communicate with each other in a wired or wireless manner or in another communication manner. The control device 302 may alternatively be installed on or integrated into the radar device 301. In this system, the radar device 301 bears a function of transmitting an electromagnetic wave by a radar, and the control device 302 is mainly configured to control transmission duration of the radar, and may further control transmit power, a frequency band, a modulation scheme, and the like of the radar.

As shown in FIG. 3, the radar device 301 is an electronic device that detects a target by using an electromagnetic wave. The radar transmits the electromagnetic wave to irradiate the target, and receives an echo of the target, to obtain information such as a distance from the target to a transmission point of the electromagnetic wave, a distance change rate (radial speed), a direction, and a height. The radar may include an early warning radar, a search alert radar, a guidance command radar, a gun targeting radar, a height measurement radar, a battlefield surveillance radar, an airborne radar, a radio height measurement radar, a radar fuze, a meteorological radar, a navigation control radar, a navigation radar, and a radar for collision avoidance and identification of friend or foe. The radar device 301 may be installed on a motor vehicle, a drone, a railcar, a bicycle, a signal light, a speed measurement apparatus, a base station, or the like. When the radar device 301 is an on-board radar (which is installed on a vehicle, and is usually an on-board millimeter-wave radar), the radar device 301 continuously occupies a frequency band to transmit an electromagnetic wave.

The control device 302 may be a server device, a communications terminal, a mobile device, a user terminal, a mobile terminal, a wireless communications device, a portable terminal, a user agent, a user apparatus, or the like, and is mainly used for data input, processing result output or display. Alternatively, the control device 302 may be a software client or an application installed or run on any one of the foregoing devices. When the radar device 301 is an on-board radar, the radar device 301 continuously occupies a frequency band to transmit an electromagnetic wave, and the control device 302 obtains interference information on the frequency band. The interference information in embodiments of this disclosure may include a quantity or density information of other radars that use the frequency band or a frequency band near the frequency band at the same time. The interference information may be obtained actively or passively. The control device 302 determines, based on the obtained interference information, transmission duration of the radar device 301 on a frequency band, and controls duration of transmitting an electromagnetic wave by the radar device 301 on a frequency band.

It may be understood that the system architecture in FIG. 3 is merely an example implementation of embodiments of the present disclosure, and the system in embodiments of the present disclosure includes but is not limited to the foregoing system architecture.

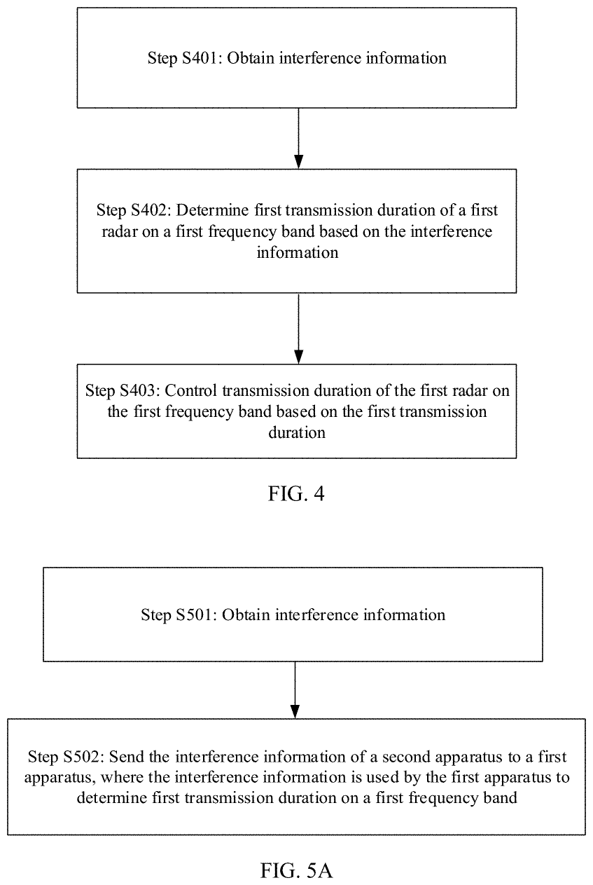

FIG. 4 is a schematic flowchart of a transmission control method according to an embodiment. The method may be applied to the system in FIG. 3. With reference to FIG. 4, the following uses an example in which an execution body is the control device 302. The control device 302 may be a part of the radar device 301 and is described from a unilateral side of the control device 302. In the transmission control method, the control device may be a part of a first radar. The method may include step S401 to step S403.

Step S401: Obtain Interference Information.

Further, the control device obtains the interference information of the first radar, where the interference information is used to represent first information of a degree to which the first radar is interfered with on a first frequency band. A source of the interference may be another radar or a roadside unit, or may be another device that transmits an electromagnetic wave.

The interference information may include a quantity or density information of interfering radars on the first frequency band, or radar information of the interfering radar (for example, at least one of a quantity of interfering radars, and a location, a transmit frequency, and transmission duration of the interfering radar). A larger quantity or a higher density of interfering radars indicates a stronger degree of interference. Both the quantity and the density information of radars that are interfered with can visually describe the degree to which the first radar is interfered with. This provides effective information for subsequently determining transmission duration. The following lists two manners of obtaining the interference information. The two manners include a manner of actively obtaining the interference information through interference detection and a manner of passively receiving the interference information by using a communications device. This can improve efficiency of obtaining the interference information.

Manner 1: The control device performs interference detection on the first frequency band to obtain the interference information. Further, that the control device obtains the interference degree through listening by the control device may be that a frequency band of a to-be-transmitted signal is adjusted to a frequency range of a detection sub-band, and a receiver on the control device mixes a signal received on the detection sub-band with the to-be-transmitted signal, and then performs energy detection after processing is performed by an intermediate frequency filter. An energy detection result is compared with a preset value, to determine a degree of density of interfering radars on the detection sub-band, and the interference information is obtained by using a listening result. The detection sub-band is a frequency domain granularity of radar listening, and the interference information herein includes density information of interfering radars. For example, that the control device obtains the interference degree through listening by the control device may be that a frequency band of a to-be-transmitted signal is adjusted to a frequency range of a detection sub-band p, and a receiver on the control device mixes a signal received on the detection sub-band with the to-be-transmitted signal, and then performs energy detection after processing is performed by an intermediate frequency filter. An energy detection result is compared with a preset value Th1, to determine a degree of density of interfering radars on the detection sub-band p. When the energy detection result is greater than the preset value Th1, it indicates that the degree of the density of the interfering radars on the detection sub-band p is relatively high. When the energy detection result is less than the preset value Th1, it indicates that the degree of the density of the interfering radars on the detection sub-band p is relatively low.

Manner 2: The control device receives the interference information, where the interference information is from at least one second apparatus, and the second apparatus includes a second radar or a roadside unit. Further, a communications module of another second apparatus loads radar information to a wireless signal for transmission. The radar information includes at least one of a quantity of radars, a location of each radar, a transmit frequency band and transmission duration of each radar, and the like. The control device receives these signals by using the communications module at a receive end, to obtain radar information carried in the wireless signal through receiving and demodulation. The communications module may be a communications module built in the control device, or may be a communications module mounted on a vehicle (for example, V2X), to obtain surrounding radar information (a quantity, occupied time-frequency resource information, waveform information, and the like), and infer a degree of density of surrounding interfering radars. The interference information may alternatively be information sent by a roadside unit. The interference information includes information collected by the roadside unit, for example, a quantity of interfering radars, and a location, a frequency band, and transmission duration of the interfering radar, and the control device receives the interference information. In a V2X communication scenario, vehicles may communicate with each other by using a sidelink (SL). SL communication is direct communication between vehicles, that is, communication between vehicles is direct communication in which no data is forwarded by using a network device. A vehicle and a network communicate with each other by using an uplink and a downlink. The uplink and the downlink are defined for a Uu interface for communication between a network device and a user, transmission from the network device to the user is downlink (DL) transmission, and transmission from the user to the network device is uplink (UL) transmission.

V2X SL communication includes two communication modes: A first communication mode is based on V2X direct communication scheduled by a network device, and means that a V2X user sends control information and data for V2X communication on a scheduled time-frequency resource based on scheduling information of the network device. The first communication mode is referred to as a mode 3 working mode. A second communication mode means that a V2X user selects, from available time-frequency resources included in a V2X communication resource pool, a time-frequency resource used for communication, and sends control information and data on the selected resource. The second communication mode is referred to as a mode 4 working mode. It should be noted that, for a scheduling request/scheduling grant in the mode 3 mode, the network device and the user still communicate with other by using the uplink and the downlink, and the vehicles directly communicate with each other by using the SL.

In a possible implementation, the interference information further includes second information used to represent a degree to which the first radar is interfered with by another radar on a second frequency band, and the degree to which the first radar is interfered with on the second frequency band is higher than the degree to which the first radar is interfered with on the first frequency band. That is, the interference information includes the first information and the second information. The control device may obtain both the interference information on the first frequency band and the interference information on the second frequency band, and determine a next transmit frequency band by comparing the interference information on the first frequency band with the interference information on the second frequency band. It may be understood that the control device may further obtain interference information on more than two frequency bands, and determine a next transmit frequency band by comparing the interference information on the plurality of frequency bands. The following uses an example in which the interference information includes the first information and the second information, to provide two manners of determining a next transmit frequency band.

Manner 1: If the degree to which the first radar is interfered with on the second frequency band is higher than the degree to which the first radar is interfered with on the first frequency band, the first frequency band is selected as the next transmit frequency band, and the interference information on the first frequency band is obtained. For example, when the interference information represents a quantity of interfering radars, it is detected that a quantity of interfering radars on the first frequency band is 3, a quantity of interfering radars on the second frequency band is 4, and the quantity of interfering radars on the second frequency band is higher than the quantity of interfering radars on the first frequency band, the first frequency band is selected as the next transmit frequency band, and the interference information on the first frequency band is obtained. It goes the same when the interference information represents density information of interfering radars, that is, a frequency band with a minimum density of interfering radars in all frequency bands is selected as the next transmit frequency band. In this manner, a transmit frequency band is determined by comparing interference information on different frequency bands, and transmission duration is subsequently determined based on interference information on the transmit frequency band, so that mutual interference between radars can be better avoided.

Manner 2: If a current transmit frequency band of the first radar is the first frequency band, when the interference information represents a quantity of interfering radars, it is detected that a quantity of interfering radars on the first frequency band is 4, and a quantity of interfering radars on the second frequency band is 3, a difference between the quantity of interfering radars on the first frequency band and the quantity of interfering radars on the second frequency band is not large. Therefore, it may be considered that the current transmit frequency band of the first radar is not changed, that is, the first frequency band is still selected as the next transmit frequency band, and the control device obtains the interference information on the first frequency band. A threshold may be preset herein, for example, a threshold is 2. To be specific, if an absolute value of a difference between a quantity of interfering radars on another frequency band and a quantity of interfering radars on a current transmit frequency band is less than 2, a current transmit frequency band of the first radar is not changed. It goes the same when the interference information represents density information of interfering radars. To be specific, if an absolute value of a difference between density of interfering radars on another frequency band and density of a quantity of interfering radars on a current transmit frequency band is less than the preset threshold, a current transmit frequency band of the first radar is not changed, that is, the current transmit frequency band is selected as the next transmit frequency band. This avoids frequent replacement of a transmit frequency band of a radar, and saves resources.

Step S402: Determine first transmission duration of the first radar on the first frequency band based on the interference information.

Further, after obtaining the interference information of the first radar on the first frequency band, the control device determines the first transmission duration of the first radar on the first frequency band based on the interference information. The interference information may have a correspondence with the first transmission duration of the first radar. When different interference degrees correspond to different transmission duration, transmission duration corresponding to a high interference degree is less than transmission duration corresponding to a low interference degree. It may be understood that the correspondence may be represented by a function formula, that is, one piece of interference information corresponds to one piece of transmission duration, or the correspondence may be represented by a preset interval, that is, a range of one piece of interference information corresponds to one piece of transmission duration, or a range of one piece of interference information corresponds to one piece of transmission duration.

The interference information may further indicate a difference between the first transmission duration and initial transmission duration of the first radar, or the interference information may further indicate the first transmission duration. The initial transmission duration may be a preset fixed value, or the initial transmission duration may be last transmission duration of the first transmission duration. Based on the interference information, the first transmission duration of the first radar on the first frequency band may be determined, or a difference between the first transmission duration of the first radar on the first frequency band and the last transmission duration or the initial transmission duration may be determined, to determine the first transmission duration of the first radar on the first frequency band. The first transmission duration may be maximum transmission duration. The control device determines maximum transmission duration of the first radar on the first frequency band based on the interference information. In an actual transmission process, the first transmission duration of the first radar on the first frequency band may not reach the maximum transmission duration.

In a possible implementation, the interference information belongs to a first interference range in a plurality of interference ranges, and the plurality of interference ranges are defined by using at least one interference threshold. The at least one interference threshold is predefined or preconfigured. That is, the at least one interference threshold is predefined, and the plurality of interference ranges are defined by using the at least one interference threshold. The obtained interference information is within one of the interference ranges. The interference threshold may be a threshold for defining upper and lower values of a range, or may be a threshold for segmenting a range.

For example, the interference information represents a quantity of interfering radars on the first frequency band. When the interference threshold is a threshold for defining upper and lower values of a range, an interference threshold for defining a first range is 0 and 3, that is, the first range includes 0 to 3 interfering radars, an interference threshold for defining a second range is 3 and 6, that is, the second range includes 3 to 6 interfering radars, and an interference threshold for defining a third range is 5 and 9, that is, the third range includes 5 to 9 interfering radars, where the interference information represents one of the three interference ranges. When the interference threshold is a threshold for segmenting a range, two interference thresholds are defined as 3 and 6, and there are three interference ranges, which may be 0 to 3 interfering radars, 3 to 6 interfering radars, and more than 6 interfering radars, where the quantity of interfering radars that is represented by the interference information falls into one of the three interference ranges. Because there may be a correspondence between the interference information and the transmission duration of the first radar, the interference information may further indicate a difference between the first transmission duration and the initial transmission duration of the first radar, or the interference information may further indicate the first transmission duration, that is, the first transmission duration of the first radar on the first frequency band may be determined by using the interference information.

In a possible implementation, if the interference information is within the first range, it is determined that the transmission duration of the first radar is first duration. If the interference information is within the second range, it is determined that the transmission duration of the first radar is second duration. A maximum value of the first range is greater than a maximum value of the second range, and a value of the first duration is less than a value of the second duration. When the interference information includes a quantity or a density range of interfering radars, the following lists two cases of a correspondence between interference information and transmission duration.

Case 1: A correspondence between a quantity or a density range of interfering radars in a plurality of pieces of interference information and transmission duration is preset. Ranges of the plurality of pieces of interference information do not overlap. The correspondence may be preset by a user, or may be preset in a standard or a protocol, or may be preset when a radar is delivered from a factory. This is not limited herein. A quantity of interfering radars on the first frequency band in the interference information is used as an example. When the quantity of interfering radars is 0 to 3, the first transmission duration corresponding to the first radar on the first frequency band is 2 seconds (s). When the quantity of interfering radars is 4 to 6, the first transmission duration corresponding to the first radar on the first frequency band is 1 s. When the quantity of interfering radars is 7 to 9, the first transmission duration corresponding to the first radar on the first frequency band is 0.2 s. When the quantity of interfering radars is more than 9, the first transmission duration corresponding to the first radar on the first frequency band is 0.1 s. According to the correspondence, the first transmission duration of the first radar on the first frequency band may be clearly determined based on the interference information.

Case 2: A correspondence between a quantity or a density range of interfering radars in a plurality of pieces of interference information and transmission duration is preset. Ranges of the plurality of pieces of interference information partially overlap. The correspondence may be preset by a user, or may be preset in a standard or a protocol, or may be preset when a radar is delivered from a factory. This is not limited herein. A quantity of interfering radars on the first frequency band in the interference information is used as an example. When the quantity of interfering radars is 0 to 3, the first transmission duration corresponding to the first radar on the first frequency band is 2 s. When the quantity of interfering radars is 3 to 6, the first transmission duration corresponding to the first radar on the first frequency band is 1 s. When the quantity of interfering radars is 5 to 9, the first transmission duration corresponding to the first radar on the first frequency band is 0.2 s. When the quantity of interfering radars is more than 8, the first transmission duration corresponding to the first radar on the first frequency band is 0.1 s. It may be learned that the four quantity ranges of interfering radars partially overlap. If the first transmission duration of the first radar on the first frequency band is currently 2 s (that is, the interference information is within the range of 0 to 3), and if it is determined that a next transmit frequency band is the first frequency band, and it is detected that the quantity of interfering radars on the first frequency band is 3, although 3 also falls within the range of the transmission duration of 1 s (that is, the quantity of interfering radars is 3 to 6), it is considered that a current state is not changed, that is, 2s is still selected as the next transmission duration. It goes the same when the interference information represents density information of interfering radars. This avoids frequent replacement of transmission duration of a radar, and saves resources. Optionally, when the first radar initially determines the transmission duration, because previous transmission duration does not exist as a reference, the initial transmission duration may be optionally a preset fixed value. Alternatively, if the obtained interference information falls within an overlapping area, the initial transmission duration is transmission duration corresponding to a range with relatively short duration or a range with relatively long duration.

Optionally, the method further includes step S403: Control transmission duration of the first radar on the first frequency band based on the first transmission duration.

Further, after determining the first transmission duration of the first radar on the first frequency band based on the first transmission duration based on the interference information, the control device controls the transmission duration of the first radar on the first frequency band based on the first transmission duration.

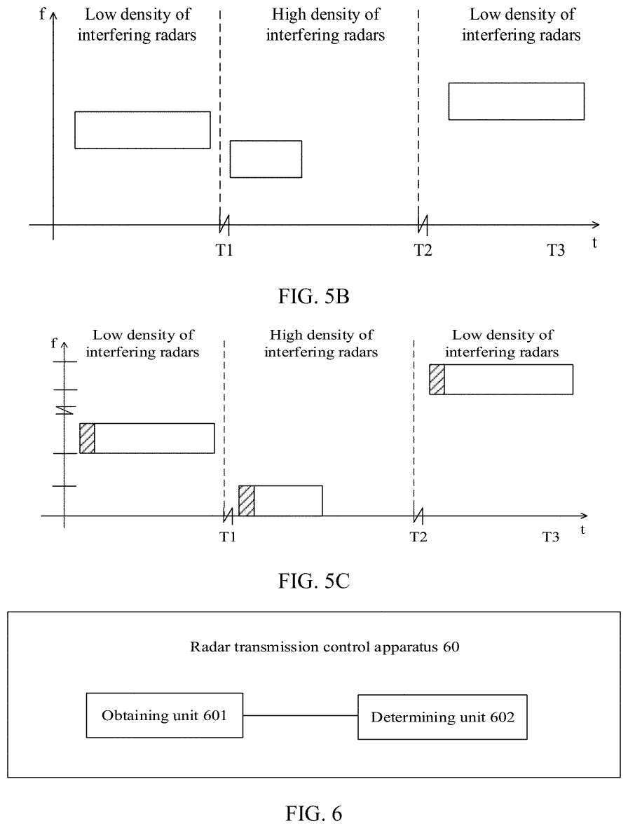

In a possible implementation, for example, as shown in FIG. 5B, before a time period of 0 to T1, the radar learns that density of interfering radars on a frequency band 1 is relatively low. Therefore, transmission duration of continuously occupying a spectrum resource by the radar on the frequency band 1 in the time period of 0 to T1 is relatively long. However, before a time period of T1 to T2, the radar learns that density of interfering radars on a frequency band 2 is relatively high. Therefore, transmission duration of continuously occupying a spectrum resource by the radar on the frequency band 2 in the time period of T1 to T2 is relatively short. Before a time period of T2 to T3, the radar learns that density of interfering radars on a frequency band 3 is relatively low. Therefore, transmission duration of continuously occupying a spectrum resource by the radar on the frequency band 3 in the time period of T2 to T3 is relatively long. The time period of 0 to T1, the time period of T1 to T2, and the time period of T2 to T3 are of order of seconds. The spectrum resource may or may not change after each adjustment, that is, the frequency band 1, the frequency band 2, and the frequency band 3 may be the same or different. This depends on a policy and a capability of the radar. Herein, an example in which the spectrum resource changes after adjustment is used. During actual application, this is not limited.

In a time period in which the frequency band 1 is not occupied in 0 to T1, a time period in which the frequency band 2 is not occupied in T1 to T2, and a time period in which the frequency band 3 is not occupied in T2 to T3, the radar may select another frequency band for transmission. A manner of selecting another transmit frequency band may be the foregoing manner 1 or manner 2. Control of transmission duration may be that, regardless of a transmit frequency band, maximum transmission duration in 0 to T1 is relatively long. For example, in the time period of 0 to T1, it is determined that the transmission duration is ⅓ T1. In this case, in a time period of the remaining ⅔ T1, the radar may select another frequency band for transmission. In this case, it is not necessary to determine the transmission duration again, and after the frequency band is selected, transmission duration on the frequency band may also be ⅓ T1. Control of transmission duration may alternatively be that each frequency band corresponds to density of interfering radars on the frequency band, that is, transmission duration is determined by using different interference information, and corresponding maximum transmission duration is correspondingly different.

In a possible implementation, for example, as shown in FIG. 5C, after determining the first frequency band, the control device first obtains the interference information on the first frequency band. A slashed-line area indicates a time at which the control device detects the first radar through listening or by using a communications module, to obtain a degree of density of surrounding interfering radars. In a time period of 0 to T1, it is learned, through listening, that density of interfering radars on a frequency band 1 is low, and therefore transmission duration of continuously occupying a spectrum resource by the radar on the frequency band 1 in the time period of 0 to T1 is relatively long. However, in a time period of T1 to T2, it is learned, through listening, that density of interfering radars on a frequency band 2 is relatively high, and therefore transmission duration of continuously occupying a spectrum resource by the radar on the frequency band 2 in the time period of T1 to T2 is relatively short. In a time period of T2 to T3, it is learned, through listening, that density of interfering radars on a frequency band 3 is low, and therefore transmission duration of continuously occupying a spectrum resource by the radar on the frequency band 3 in the time period of T2 to T3. The time period of 0 to T1, the time period of T1 to T2, and the time period of T2 to T3 are of order of seconds. The spectrum resource may or may not change after each adjustment, that is, the frequency band 1, the frequency band 2, and the frequency band 3 may be the same or different. This depends on a policy and a capability of the radar. Herein, an example in which the spectrum resource changes after adjustment is used, and the spectrum resource is one or more channels obtained through division. During actual application, this is not limited. In a time period in which the frequency band 1 is not occupied in 0 to T1, a time period in which the frequency band 2 is not occupied in T1 to T2, and a time period in which the frequency band 3 is not occupied in T2 to T3, the radar may select another frequency band for transmission. A manner of selecting another transmit frequency band may be the foregoing manner 1 or manner 2. Control of transmission duration may be that, regardless of a transmit frequency band, maximum transmission duration in 0 to T1 is relatively long. For example, in the time period of 0 to T1, it is determined that the transmission duration is ⅓ T1. In this case, in a time period of the remaining ⅔ T1, the radar may select another frequency band for transmission. In this case, it is not necessary to determine the transmission duration again, and after the frequency band is selected, transmission duration on the frequency band may also be ⅓ T1. Control of transmission duration may alternatively be that each frequency band corresponds to density of interfering radars on the frequency band, that is, transmission duration is determined by using different interference information, and corresponding maximum transmission duration is correspondingly different.

In conclusion, in the transmission control method in embodiments of this disclosure, the interference information of the first radar on the first frequency band may be first obtained. The interference information represents the degree to which the first radar is interfered with on the first frequency band. A device determines the transmission duration of the first radar on the first frequency band based on the obtained interference information, where the interference information may indicate the difference between the transmission duration and the initial transmission duration of the first radar, or may directly indicate the transmission duration. Finally, the transmission duration of the first radar on the first frequency band is controlled by using the determined transmission duration, and the transmission duration of the radar is controlled by using the interference information, to adjust transmission duration of continuously occupying a resource, so as to avoid a case in which one radar continuously occupies a frequency resource, and correspondingly control a length of the duration based on intensity of the interference. This achieves fairness of resource sharing between a plurality of radars, and effectively avoids interference.

The following describes another transmission control method by using the second apparatus in the manner 2 of step S401 in the foregoing embodiment as an execution body. The second apparatus may be another radar or a roadside unit, or may be a control device of another radar or a control device of a roadside unit. In the transmission control method in this disclosure, a first apparatus may be the first radar in embodiments of this disclosure. As shown in FIG. 5A, when the second apparatus is a control device of another radar, the method may include step S501 and step S502.

Step S501: Obtain Interference Information.

Further, the control device obtains the interference information of the second apparatus, and the interference information is used to represent a degree to which the second apparatus is interfered with on a first frequency band. For this step of obtaining interference information of the second apparatus, refer to the description of obtaining the interference information of the first radar in step S401 in the foregoing embodiment. Details are not described herein again.

Step S502: Send the interference information of the second apparatus to the first apparatus, where the interference information is used by the first apparatus to determine first transmission duration on the first frequency band.

Further, after obtaining the interference information of the second apparatus, the control device may control transmission duration of the second apparatus by using step S402 and step S403 in the foregoing embodiment. Then, the control device sends radar information of the control device to another apparatus (for example, the first apparatus or the first radar) by using a communications module or a V2X module. The radar information includes a quantity of radars of the second apparatus, and a location, a transmit frequency band, and transmission duration of the radar. The first radar is used as an example. The first radar receives radar information of the second apparatus, and determines, based on the received radar information, whether the second apparatus is an interfering radar. If a radar transmit frequency band of the second apparatus is the same as or similar to a radar transmit frequency band of the first radar, and transmission duration of the second apparatus and transmission duration of the first radar overlap, interference between the second apparatus and the first radar is relatively strong, and the radar information of the second apparatus is included in interference information of the first radar. The first radar obtains the interference information of the first radar based on one or more pieces of received radar information, where the interference information of the first radar represents a degree to which the first radar is interfered with on the first frequency band, and then performs step S402 and step S403 in the foregoing embodiment to control transmission duration of the first radar.

When the second apparatus is a control device of a roadside unit, the method may include step S502.

Step S502: Send the interference information of the second apparatus to the first apparatus, where the interference information is used by the first apparatus to determine first transmission duration of the first apparatus on the first frequency band.

Further, the control device collects radar information of a peripheral radar, and the radar information includes information such as a quantity of radars, and a location, a transmit frequency band, and transmission duration of each radar. The control device sends the interference information to the first apparatus after integration by using a V2X module, and the interference information is used to represent a degree to which the first apparatus is interfered with on the first frequency band. The first radar is used as an example. The first radar receives the degree to which the first apparatus is interfered with on the first frequency band, and then performs step S402 and step S403 in the foregoing embodiment to control transmission duration of the first radar.

In general, the transmission control method describes a process of providing the radar information of the second apparatus. In this way, the first radar determines the interference information by using the obtained radar information, to determine the transmission duration of the first radar by using the interference information. In this implementation, the second apparatus actively provides the interference information. The first radar controls the transmission duration of the first radar by using the interference information, and adjusts transmission duration of continuously occupying a resource, so as to avoid a case in which one radar continuously occupies a frequency resource, and correspondingly control a length of the duration based on intensity of the interference. This achieves fairness of resource sharing between a plurality of radars, and effectively avoids interference.

The foregoing describes the method in embodiments of this disclosure in detail, and the following provides a related transmission control apparatus in embodiments of this disclosure. The transmission control apparatus may be a terminal device, such as a radar, that has a computing function, may be connected to an intelligent terminal or various terminal devices, and exists in a form of a portable accessory. Alternatively, the transmission control apparatus may be a server device that has a computing function and may be connected to various devices, or may be an element in the foregoing device, for example, a chip. FIG. 6 is a schematic diagram of a transmission control apparatus according to an embodiment. The transmission control apparatus 60 includes an obtaining unit 601 and a determining unit 602, and may further include a receiving unit 603.

The first obtaining unit 601 is configured to obtain interference information, where the interference information is used to represent first information of a degree to which a first radar is interfered with on a first frequency band.

The determining unit 602 is configured to determine first transmission duration of the first radar on the first frequency band based on the interference information, where the interference information is used to indicate a difference between the first transmission duration and initial transmission duration of the first radar, or the interference information is used to indicate the first transmission duration.

In a possible implementation, the interference information includes a quantity of radars that are interfered with on the first frequency band, or includes density information of radars that are interfered with on the first frequency band. Both the quantity and the density information of radars that are interfered with can visually describe the degree to which the first radar is interfered with. This provides effective information for subsequently determining transmission duration.

In a possible implementation, the obtaining unit 601 is further configured to perform interference detection on the first frequency band to obtain the interference information, or the obtaining unit 601 further includes a receiving unit 603 configured to receive the interference information, where the interference information is from at least one second apparatus, and the second apparatus includes a second radar or a roadside unit. This implementation provides two manners of obtaining the interference information by the obtaining unit in the apparatus, including a manner of actively obtaining the interference information through interference detection and a manner of passively receiving the interference information by using a communications device. This can improve efficiency of obtaining the interference information.

In a possible implementation, the interference information belongs to a first interference range in a plurality of interference ranges, and the plurality of interference ranges are defined by using at least one interference threshold. In this implementation, a specific interference range that is in the plurality of interference ranges and to which the interference information belongs is determined, so as to determine the transmission duration of the first radar, thereby effectively avoiding interference from another radar, and ensuring fairness of resource sharing between a plurality of radars while satisfying a detection requirement of the first radar.

In a possible implementation, the at least one interference threshold is predefined or preconfigured. In this implementation, the plurality of interference ranges is determined by using the at least one preset interference threshold, so as to determine a specific interference range that is in the plurality of interference ranges and to which the interference information belongs, and determine the transmission duration of the first radar.

In a possible implementation, the interference information further includes second information used to represent a degree to which the first radar is interfered with by another radar on a second frequency band, and the degree to which the first radar is interfered with on the second frequency band is higher than the degree to which the first radar is interfered with on the first frequency band. In this implementation, a transmit frequency band is determined by obtaining and comparing interference information on different frequency bands, and transmission duration is subsequently determined based on interference information on the transmit frequency band, so that mutual interference between radars can be better avoided.

It should be noted that, for functions of the function units in the transmission control apparatus 60 described in embodiments of this disclosure, refer to related descriptions of step S401 to step S403 in the method embodiment described in FIG. 4. Details are not described herein again.

FIG. 7 is a schematic diagram of another transmission control apparatus according to an embodiment. The transmission control apparatus 70 includes a sending unit 701.

The sending unit 701 is configured to send interference information to a first apparatus, where the interference information includes first information used to represent a degree to which the first apparatus is interfered with on a first frequency band, so that the first apparatus determines first transmission duration of the first apparatus on the first frequency band based on the interference information.

In a possible implementation, the interference information includes a quantity of radars that are interfered with on the first frequency band, or includes density information of radars that are interfered with on the first frequency band.

It should be noted that, for functions of the function units in the transmission control apparatus 70 described in embodiments of this disclosure, refer to related descriptions of step S501 and step S502 in the method embodiment. Details are not described herein again.

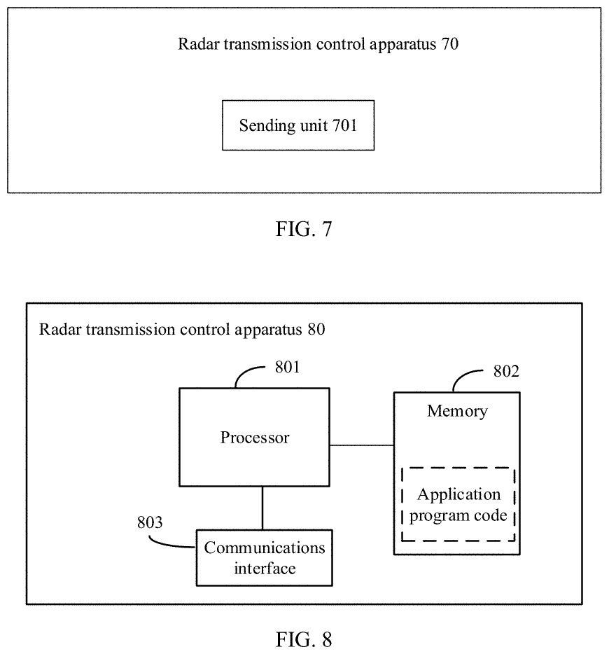

FIG. 8 is a schematic diagram of a structure of another transmission control apparatus according to an embodiment. The apparatus 80 includes at least one processor 801, at least one memory 802, and/or at least one communications interface 803. In addition, the device may further include common components such as an antenna. Details are not described herein again.

The processor 801 may be a general-purpose CPU, a microprocessor, an application-specific integrated circuit (ASIC), or one or more integrated circuits configured to control execution of the foregoing solution program.

If the apparatus includes a communications interface 803, the communications interface is configured to communicate with another device or a communications network, such as the Ethernet, a radio access network (RAN), a core network, or a wireless local area network (WLAN).

If the apparatus includes the memory 802, the memory may be a read-only memory (ROM) or another type of static storage device that can store static information and instructions, a random-access memory (RAM) or another type of dynamic storage device that can store information and instructions, or may be an electrically erasable programmable ROM (EEPROM), a compact disc (CD) ROM (CD-ROM) or another optical disk storage, an optical disc storage (including a compressed optical disc, a laser disc, an optical disc, a DIGITAL VERSATILE DISC (DVD), a BLU-RAY DISC, or the like), a magnetic disk storage medium, or another magnetic storage device, or any other medium that can be used to carry or store program code expected in a form of an instruction or a data structure and that can be accessed by a computer, but is not limited thereto. The memory may exist independently, and is connected to the processor through a bus. Alternatively, the memory may be integrated with the processor.

The memory 802 is configured to store application program code for executing the foregoing solution, and is controlled and executed by the processor 801. The processor 801 is configured to execute the application program code stored in the memory 802.

The code stored in the memory 802 may be configured to execute the foregoing transmission control method provided in FIG. 4, for example, obtain interference information, where the interference information is used to represent an interference degree of the first radar on the first frequency band. Determining transmission duration of the first radar on the first frequency band according to the interference information, and There is a correspondence between the interference information and transmission duration of the first radar. When different interference degrees correspond to different transmission duration, transmission duration corresponding to a high interference degree is less than transmission duration corresponding to a low interference degree. Controlling, according to the transmission duration, the transmission duration of the first radar on the first frequency band.

It should be noted that, for functions of the function units in the transmission control apparatus 80 described in embodiments of this disclosure, refer to related descriptions of step S401 to step S403 in the method embodiment described in FIG. 4. Details are not described herein again. Alternatively, for functions of the function units in the transmission control apparatus 80 described in embodiments of this disclosure, refer to related descriptions of step S501 and step S502 or step S503 in the foregoing method embodiment. Details are not described herein again.

The following provides a radar transmission control system related to an embodiment.

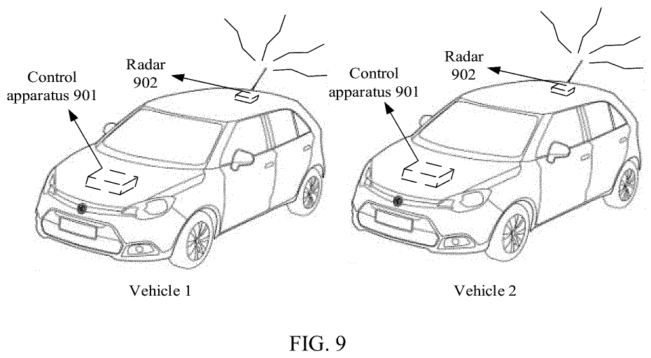

In a first optional design, as shown in FIG. 9, the radar transmission system may include a plurality of vehicles. An in-vehicle system of each vehicle includes at least one radar 902 and a control apparatus 901 (the control apparatus 901 may be the control apparatus provided in the foregoing embodiment). The plurality of vehicles communicate with each other by using a communications module. The control apparatus 901 determines transmission duration of the radar 902 on a frequency band based on obtained interference information, and controls transmission duration of the radar 901 on the frequency band. The following uses FIG. 9 as an example to describe a radar transmission control process between two vehicles. A vehicle 1 first obtains interference information detected by the vehicle 1 or interference information sent by another vehicle, and determines a transmit frequency band and transmission duration of a radar 902 of the vehicle 1 based on the interference information by using a control apparatus 901 of the vehicle 1. Then, the vehicle 1 sends radar information (including a quantity of radars, and a location, a transmit frequency band, and transmission duration of the radar) of the vehicle 1 to a vehicle 2 by using a communications module. The vehicle 2 receives, by using a communications module, the radar information of the vehicle 1 that is sent by the vehicle 1. If a radar frequency band of the vehicle 1 is the same as or similar to a radar frequency band of the vehicle 2, and transmission duration of the vehicle 1 and transmission duration of the vehicle 2 overlap, radar interference between the vehicle 1 and the vehicle 2 is relatively strong. A control apparatus 901 of the vehicle 2 obtains the interference information, and determines a transmit frequency band and transmission duration of the radar 902 of the vehicle 2 based on the interference information.

In a second optional design, the radar transmission control system includes at least one radar and a control apparatus (the control apparatus 901 may be the control apparatus provided in the foregoing embodiment), and the system may be disposed on a single vehicle.

In this optional design, the at least one radar 902 includes the control apparatus 901.

In this optional design, the radar transmission control system further includes a fusion apparatus and/or a central controller. The fusion apparatus is configured to process data and/or a signal from at least one sensor. The central controller is configured to control the vehicle based on detection information of the at least one sensor. Controlling the vehicle may be controlling driving of the vehicle or controlling a device integrated into the vehicle, such as braking or deceleration. Further, the fusion apparatus may be integrated into the central controller.

In still another optional design, an embodiment provides a vehicle, and the vehicle includes the radar transmission control system in the second optional design. A sensor included in the vehicle may include at least one radar and/or at least one camera.

In the foregoing embodiments, descriptions of the embodiments have respective focuses. For a part that is not described in detail in an embodiment, refer to related descriptions in other embodiments.

It should be noted that, for brief description, the foregoing method embodiments are represented as a series of actions. However, a person skilled in the art should appreciate that this disclosure is not limited to the described sequence of the actions, because some steps may be performed in another sequence or simultaneously according to this disclosure. It should be further appreciated by persons skilled in the art that the embodiments described in this specification all belong to preferred embodiments, and the involved actions and modules are not necessarily required.

In the several embodiments provided in this disclosure, it should be understood that the disclosed apparatus may be implemented in other manners. For example, the described apparatus embodiments are merely examples. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electrical form or another form.

The foregoing units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit. The integrated unit may be implemented in a form of hardware, or may be implemented in a form of a software function unit.

When the foregoing integrated unit is implemented in the form of a software functional unit and sold or used as an independent product, the integrated unit may be stored in a computer-readable storage medium. Based on such an understanding, the technical solutions of this disclosure essentially, or the part contributing to the conventional technology, or all or some of the technical solutions may be implemented in a form of a software product. The computer software product is stored in a storage medium and includes several instructions for instructing a computer device (which may be a personal computer, a server, or a network device, and may be further a processor in the computer device) to perform all or some of the steps of the methods described in the embodiments of this disclosure. The foregoing storage medium may include any medium that can store program code, such as a Universal Serial Bus (USB) flash drive, a removable hard disk, a magnetic disk, an optical disc, a ROM, or a RAM.

The foregoing embodiments are merely intended to describe the technical solutions of this disclosure, but not to limit this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of this disclosure.

What is claimed is:

1. A transmission control method comprising:
obtaining interference information comprising first information representing a first degree to which a first radar is interfered with on a first frequency band;
determining a first transmission duration of the first radar on the first frequency band based on the interference information, wherein the interference information indicates a difference between the first transmission duration and an initial transmission duration of the first radar or indicates the first transmission duration.

2. The transmission control method of claim 1, wherein the interference information further comprises a quantity of radars that are interfered with on the first frequency band.

3. The transmission control method of claim 1, wherein the interference information further comprises density information of radars that are interfered with on the first frequency band.

4. The transmission control method of claim 1, further comprising performing interference detection on the first frequency band to obtain the interference information.

5. The transmission control method of claim 1, further comprising receiving the interference information from a second apparatus comprising a second radar.

6. The transmission control method of claim 1, further comprising receiving the interference information from a second apparatus comprising a roadside unit.

7. The transmission control method of claim 1, wherein the interference information is in a first interference range in a plurality of interference ranges, and wherein the method further comprises defining the plurality of interference ranges using an interference threshold.

8. The transmission control method of claim 7, wherein the interference threshold is predefined.

9. The transmission control method of claim 7, wherein the interference threshold is preconfigured.

10. The transmission control method of claim 1, wherein the interference information further comprises second information representing a second degree to which the first radar is interfered with by another radar on a second frequency band, and wherein the second degree is higher than the first degree.

11. A transmission control method comprising:
sending, to an apparatus, interference information comprising first information representing a degree to which the apparatus is interfered with on a frequency band to enable the apparatus to determine, using the first information, a transmission duration on the frequency band.

12. The transmission control method of claim 11, wherein the interference information further comprises a quantity of radars that are interfered with on the frequency band.

13. The transmission control method of claim 11, wherein the interference information further comprises density information of radars that are interfered with on the frequency band.

14. A control apparatus, comprising:
a processor; and
a non-transitory storage medium configured to communicate with the processor and store instructions, wherein, when executed by the processor, the instructions cause the control apparatus to:
obtain interference information comprising first information of a first degree to which a first radar is interfered with on a first frequency band;
determine a first transmission duration of the first radar on the first frequency band based on the interference information, wherein the interference information indicates either a difference between the first transmission duration and an initial transmission duration of the first radar, or the first transmission duration.

15. The control apparatus of claim 14, wherein the interference information further comprises a quantity of radars that are interfered with on the first frequency band or density information of the radars.

16. The control apparatus of claim 14, wherein, when executed by the processor, the instructions further cause the control apparatus to perform interference detection on the first frequency band to obtain the interference information.

17. The control apparatus of claim 14, wherein, when executed by the processor, the instructions further cause the control apparatus to receive the interference information from a second apparatus comprising either a second radar or a roadside unit.

18. The control apparatus of claim 14, wherein the interference information is in a first interference range in a plurality of interference ranges, and wherein the interference ranges are defined using an interference threshold.

19. The control apparatus of claim 18, wherein the interference threshold is either predefined or preconfigured.

20. The control apparatus of claim 14, wherein the interference information further comprises second information representing a second degree to which the first radar is interfered with by another radar on a second frequency band, and wherein the second degree is higher than the first degree.
